(19) United States
(12) Patent Application Publication
(10) Pub. No.: US 2016/0198676 A1
(43) Pub. Date: Jul. 14, 2016

(54) Pet Bowl with Chilled Insert

(71) Applicant: Bret Wooten, Lewisville, TX (US)

(72) Inventor: Bret Wooten, Lewisville, TX (US)

(21) Appl. No.: 14/980,640

(22) Filed: Dec. 28, 2015

Related U.S. Application Data
(60) Provisional application No. 62/103,272, filed on Jan. 14, 2015.

(51) Int. Cl. A01K 5/00

(52) U.S. Cl. CPC A01K 5/00

(57) ABSTRACT

A food and water bowl assembly is provided with a removable insert that can be chilled and used to maintain freshness of food and water placed within the bowl interior. The bowl assembly comprises an outer bowl, a removable insert that nests within the bowl interior, and a lid. The insert comprises a base with upstanding sidewalls, whereby the interior of the insert or the material of the insert is freezable within a conventional freezer. Along the interior of the insert is an upstanding post, which prevents over consumption by a pet, and furthermore supports a temperature indicator. The temperature indicator marks the exact or relative temperature of the insert interior for a user to gauge the freshness of the bowl assembly contents. The insert may comprise a freezable medium within its base, upstanding post, or sidewalls, whereby the medium freezes and chills contents placed within the insert interior.

### CROSS REFERENCE TO RELATED APPLICATION

This application claims the benefit of U.S. Provisional Application No. 62/103,272 filed on Jan. 14, 2015. The above identified patent application is herein incorporated by reference in its entirety to provide continuity of disclosure.

### BACKGROUND OF THE INVENTION

### Field of the Invention

The present invention relates to food containers and food bowls. More specifically, the present invention relates to pet food bowls and travel containers that have the capacity to cool food over a period of time to maintain a proper temperature and freshness thereof.

Household pets require proper care and attention from owners to remain well fed and healthy. One of the reasons for illness in many household pets results from food and drinking water contamination, in which the food and water is left open in a bowl for hours and is not maintained or replenished. This not only affects the flavor of the food and water, but can adversely affect the health of the animal if bacteria or mold develops. Some pet owners may place pet food or water inside a larger bowl filled with ice cubes, but this is not always sufficient and may pose a choking hazard. Moreover, certain pets may require fresh foods with higher protein content. This type of food is particularly susceptible to airborne bacteria and can quickly lose its quality when exposed to warmer temperatures.

The present invention provides a new and improved pet bowl that supports food or water in an enclosed and chilled environment, while also providing a means to transport the same in a safe and sanitary manner. The device provides a dual purpose travel container and pet bowl for direct consumption of food or water therefrom. The pet bowl comprises an assembly having a freezable interior bowl or insert, an outer bowl, and a lid to seal the contents of the assembly. The interior insert can be removed from the bowl and frozen in a kitchen freezer or equivalent, whereafter the insert remains frozen for a prolonged period of time and is used to chill the contents of the assembly while traveling or during periods in which food is left exposed for periods of time. An upstanding post within the insert serves several purposes, and furthermore includes a temperature gauge for the user to visualize the temperature, and thus freshness, of the bowl contents.

Overall, the present invention ensures pet food or water remains at a safe and proper temperature until consumption. The assembly maintains the flavor of the food and its texture, while decreasing the chance of food-borne illnesses. The assembly can also assist on hot days by cooling animal's body temperature through consumption of chilled water or food. Finally, the assembly provides pet owners with comfort and peace of mind that the food or water being served to the pet is fresh, even after a prolonged period in the assembly.

### SUMMARY OF THE INVENTION

The following summary is intended solely for the benefit of the reader and is not intended to be limiting in any way. The present invention provides a new bowl assembly, wherein the same can be utilized for providing convenience for the user when storing or serving water or food to a pet.

It is therefore an object of the present invention to provide a new and improved bowl assembly that has all of the advantages of the prior art and none of the disadvantages.

It is another object of the present invention to provide a bowl assembly

Another object of the present invention is to provide a bowl assembly that comprises a bowl, a removable insert that is nested within the bowl interior, and a bowl lid.

Another object of the present invention is to provide a bowl assembly that comprises an outer bowl having upstanding sidewalls, a base, an upper edge, an open upper, and an interior volume.

Another object of the present invention is to provide a bowl assembly that comprises a removable insert having a base, upstanding sidewalls, an upper edge, an open upper, and an interior volume.

Another object of the present invention is to provide a bowl assembly wherein the bowl interior volume and open upper are sized to receive the removable insert therein such that the upper edge of the removable insert is below or substantially in plane with the upper edge of the bowl when disposed therein.

Another object of the present invention is to provide a bowl assembly that comprises an upstanding post member extending from the base of the removable insert and within the interior volume thereof. The upstanding post member has a height and an upper surface, whereby the height of the upstanding post is less than or substantially in plane with the upper edge of the removable insert.

Another object of the present invention is to provide a bowl assembly whereby the upper surface of the upstanding post member has a temperature indicator thereon, whereby the temperature indicator is one that registers the exact temperature or provides a relative indication of the temperature.

Another object of the present invention is to provide a bowl assembly whereby the removable insert comprises a hollow space within at least one of the sidewalls, upstanding post, and/or base. The hollow space is filled with a freezable medium that freezes when placed within a residential kitchen freezer.

Another object of the present invention is to provide a bowl assembly whereby the lid is removably affixable to the upper edge of the bowl.

Another object of the present invention is to provide a bowl assembly whereby the bowl further comprises a thermally insulating structure to maintain the chilled temperature of the insert and thus the chilled temperature within the insert interior when the insert is chilled and the insert is disposed within the bowl interior.

Another object of the present invention is to provide a bowl assembly whereby the outer bowl further comprises a hollow space within at least one of the sidewalls or the base. The hollow space of the bowl is filled with a thermally insulating material.

Another object of the present invention is to provide a bowl assembly whereby the freezable medium of the insert is water or other suitable freezable medium, such as a freezable gel. One embodiment of the freezable gel comprises a combination of water, propylene glycol, and sodium carboxymethyl cellulose.

Another object of the present invention is to provide a bowl assembly whereby the freezable medium has a freezing point comparable to water at a given pressure. In one embodiment, the freezing point is roughly thirty-two degrees Fahrenheit and below thirty-five degrees Fahrenheit, such that it freezes when the insert is placed within a freezer appliance environment.

Another object of the present invention is to provide a bowl assembly whereby the removable insert further comprising a filler hole for filling the hollow space with the freezable medium.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows an exploded view of the bowl assembly of the present invention.

FIG. 2 shows a view of an embodiment of the bowl assembly of the present invention.

FIG. 3 shows another view of an embodiment of the bowl assembly of the present invention.

FIG. 4 shows a view of the bowl assembly of the present invention in a working state.

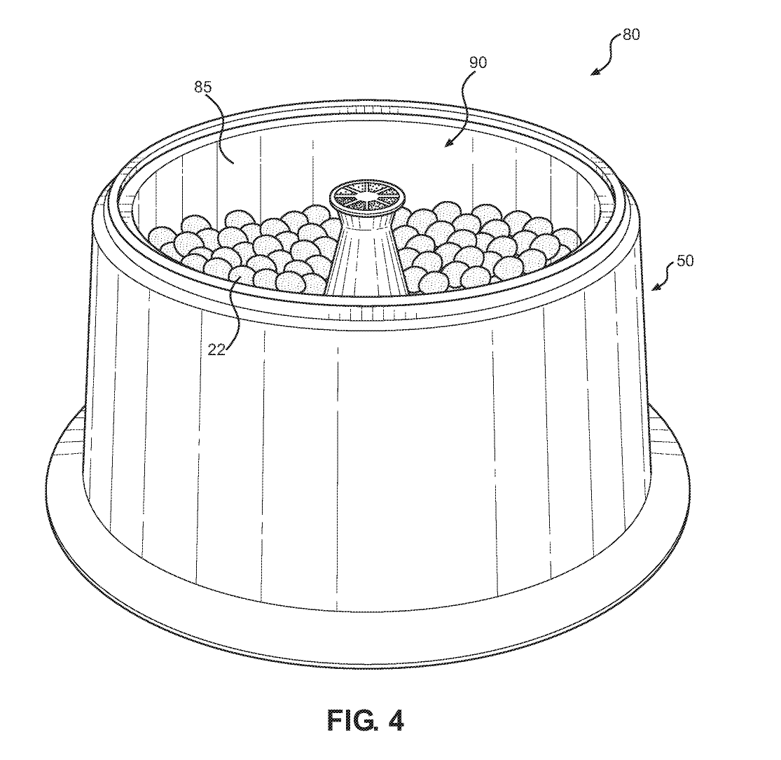

### DETAILED DESCRIPTION OF THE INVENTION

Reference is made herein to the attached drawings. Like reference numerals are used throughout the drawings to depict like or similar elements of the bowl assembly of the present invention. For the purposes of presenting a brief and clear description of the present invention, the preferred embodiment will be discussed as used for chilling the contents of the bowl using a freezable insert and a bowl structure that receives the insert and thermally insulates the same. The figures are intended for representative purposes only and should not be considered to be limiting in any respect.

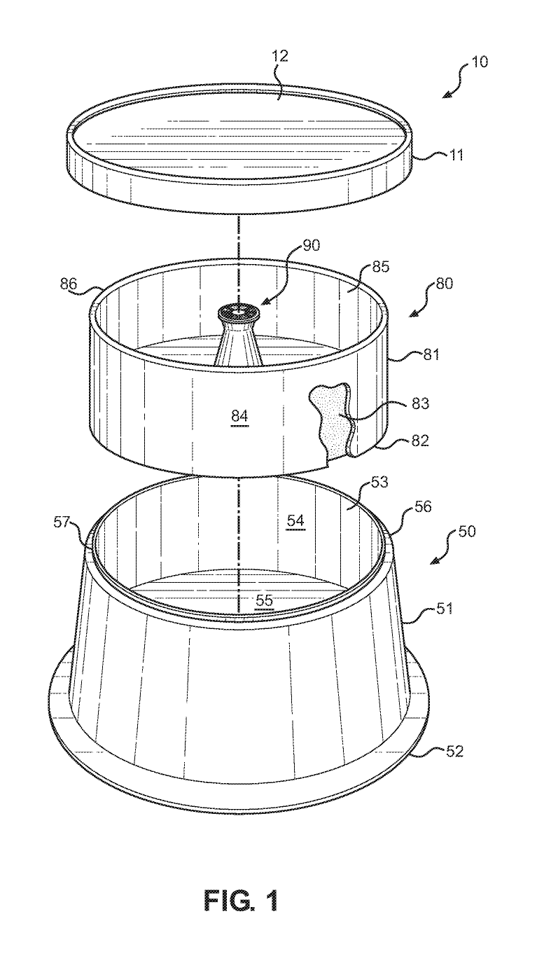

Referring now to FIG. 1, there is shown an exploded view of the bowl assembly of the present invention. The bowl assembly comprises an outer bowl 50, a removable insert 80 that is nestable within the outer bowl 50, and a lid 10 that affixes over the insert 80 and the outer bowl 50. The insert 80 is removable from the outer bowl 50 and is used to support food items therein, particularly for animals or while otherwise traveling. The insert 80 is removable such that it can be frozen or chilled, whereafter the food contents within its interior remain fresh for extended periods once nested within the outer bowl 50 and covered by the lid 10. In this manner, food can be stored in the assembly while traveling. Food can also be chilled for periods of time before being offered for consumption. The bowl assembly is ideal for traveling parents and for pet owners.

The outer bowl 50 comprises a hollow structure with upstanding sidewalls 51 and a base 52, thereby forming an interior volume 53 suitable for supporting the insert 80 therein. The interior volume 53 of the outer bowl 50 comprises a base interior surface 55 and one or more sidewall interior surfaces 54. The insert 80 similarly comprises upstanding sidewalls 81, a base 82, and an open interior volume 85. The outer surface 84 of the insert sidewalls 81 is adapted to conform, abut, or otherwise be received within the interior 53 of the outer bowl 50 such that the insert is nested therein. In one embodiment, the outer surface 84 of the insert 80 be bear against the interior surface 54 of the sidewalls 54 of the bowl. In other embodiments, the surfaces may be offset by a distance and may not abut completely against one another.

The outer bowl 50 further comprises an open upper and an upper edge 56. The upper edge 56 of the bowl is adapted to be higher or substantially equal to the upper edge 86 of the insert 80 when the insert 80 is placed within the bowl interior 53. In this way, the insert upper edge 86 does not interfere with the connection between the lid 10 and the outer bowl 50. More specifically, the upper edge 86 of the removable insert is below or substantially in plane with the upper edge 56 of the bowl when disposed therein.

The lid 10, for its part, secures to one of the bowl upper edge 56 or the insert upper edge 86. The lid 10 comprises a lid surface 10 that is coextensive with the open upper of the insert open upper and the bowl open upper such that the lid can secure over the interior volumes thereof. The lid 10 further comprises a lip or lid connector 11 along the periphery of the lid surface 12. The lid connector 11 secures the lid 10 to either the upper end 86 of the insert 80, or preferably to the upper edge 56 of the outer bowl 50. The outer bowl 50 may further comprise a complimentary connector 57 along its periphery to connect to the lid connector 11. In any embodiment, the lid secures to the bowl or the insert and remains in position until lifted or pried away by the user.

Referring to FIGS. 1-3, the insert is shown in greater detail. The insert 80 comprises an open interior 85 adapted to receive food therein. The interior further comprises an upstanding post member 90 extending from the base 82 thereof and within the interior volume. The upstanding post member 90 has a height 91 and an upper surface 92, whereby the height 91 of the upstanding post 90 is less than or substantially in plane with the upper edge 86 of the removable insert 80. The upstanding post 90 provides an upstanding member that extends through food in the insert interior, thereby preventing rapid consumption by a pet. Additionally, the increased surfaces area within the liner provided by the interior surface and the upstanding post allows the freezable medium to cool the contents therein and be in closer contact with the contents. In some embodiments, the freezable medium is disposed within the sidewalls, base, and upstanding post of the insert, providing extended volume for the freezable medium and a greater cooling surface area. In addition, the upstanding post provides a means for the user to grasp and remove the interior insert from the insulated base without contacting the sidewalls or the food therein. Finally, the upper surface 92 of the upstanding post member further comprises a temperature indicator 100 thereon. The temperature indicator 100 is used to register the exact or relative temperature within the interior of the insert such that a user can gauge the freshness of food therein after a prolonged period away from refrigeration.

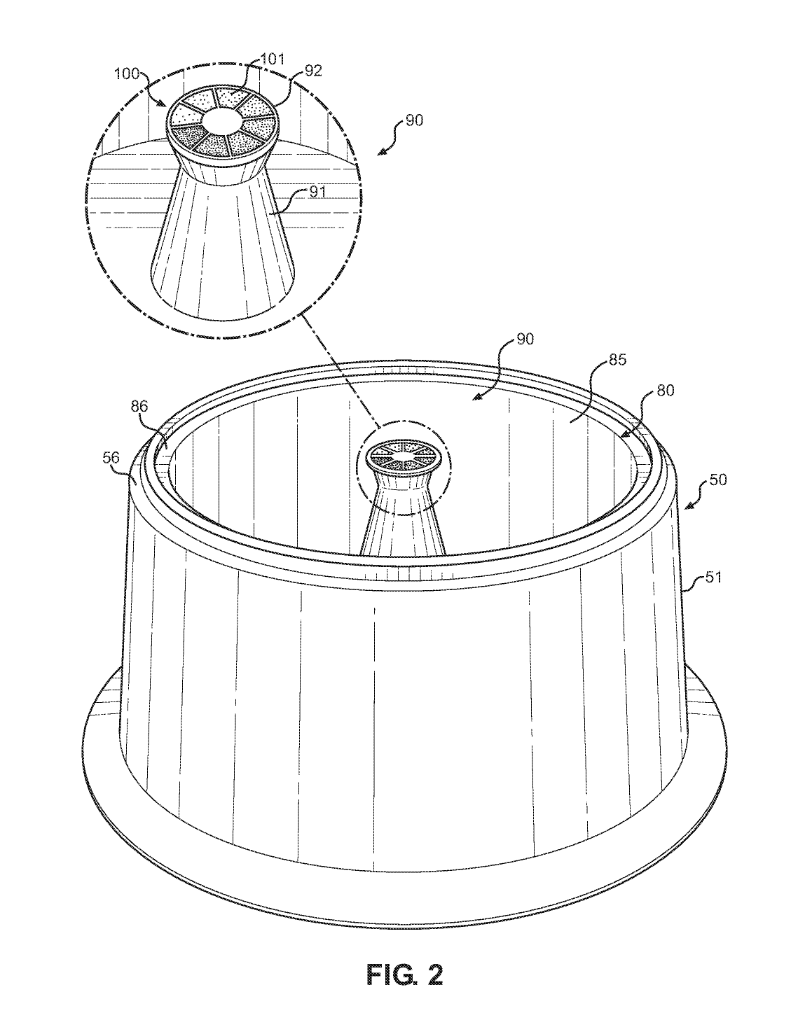

The temperature indicator 100 comprises one of a relative or exact temperature gauge. The relative gauge, as shown in FIGS. 1-2, provides a colored indicator that changes color based on the temperature within the insert interior. In particular, indicia 101 along the upper surface 92 of the post reacts to temperature, whereby the indicia is a thermochromatic material that reacts to changes in temperature. The material is designed to register temperatures between freezing and refrigerated temperatures, whereby the indicia displays a certain color when the insert interior is chilled or cooled. When the insert interior reaches room temperature, or temperatures above refrigeration temperatures for food products, the indicia changes its color to indicate the change in state. The temperature indicator 100 therefore is useful for visualizing the refrigeration level of food in the insert interior, and thus the freshness thereof.

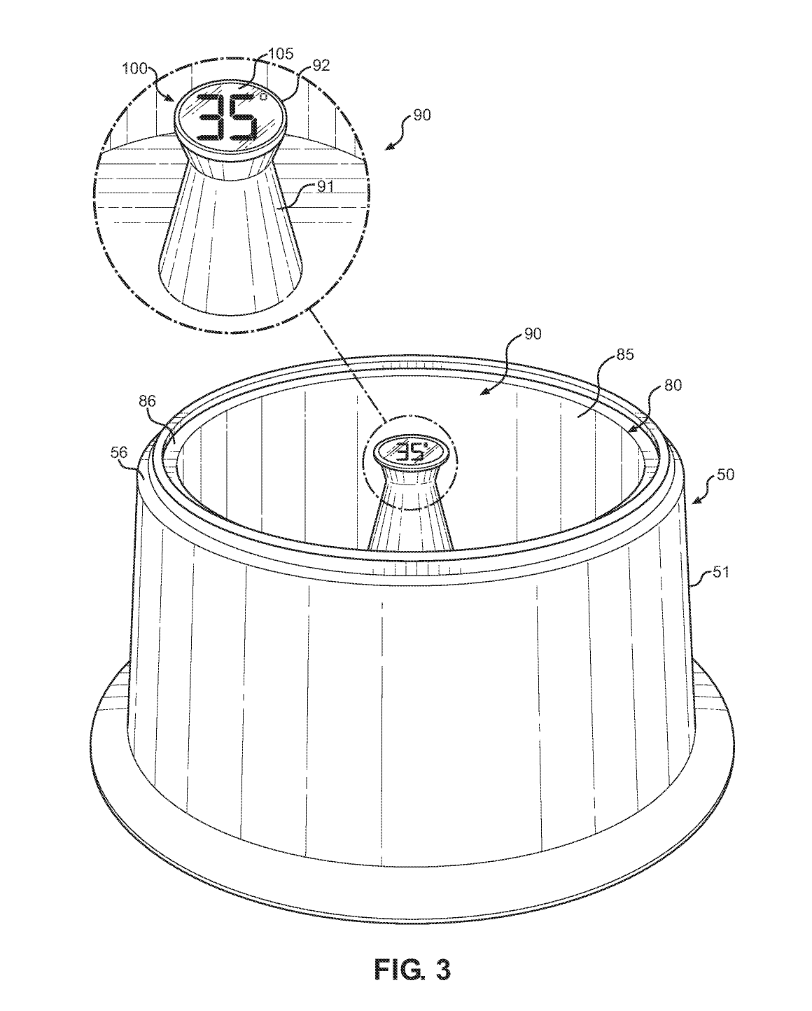

Another embodiment of the temperature indicator 100 is shown in FIG. 3. In this embodiment, the temperature indicator 100 is an exact or specific temperature indicator. In particular, this embodiment provides a digital or analog display 105 that provides a temperature reading reflecting the temperature of the insert environment. This embodiment is an active device that requires electrical power. A battery power supply may be provided in the interior of the upstanding post member 90, whereby power is supplied to the display 105 and the display shows the user the exact temperature of the insert interior.

Referring now to FIG. 1, there is shown a cut-away of the insert 80. This view illustrates the structure of the insert 80, which is one that can be frozen or chilled to cool the contents within its interior volume 85. Specifically, the insert 80 comprising a hollow space 83 within at least one of its sidewalls 81, upstanding post 90, and/or base 82, whereby the hollow space 83 is filled with a freezable medium that freezes when placed within a freezer environment. The freezable medium is one that is enclosed within the hollow space 83, or alternatively is one that can be removed and periodically replaced with replacement freezable medium. In one embodiment, the hollow space 83 is sealed. In another embodiment, hollow space 83 is adapted to be filled via a filler hole along one of the sidewalls 81 or base 82. The filler hole is used for filling the hollow space 83 with a freezable medium.

The freezable medium is one that can freeze when placed within a residential freezer environment, or in temperatures closely aligned with the freezing temperature of water. The freezable medium preferably has a freezing point comparable or roughly equal to water at a given pressure. In one embodiment, the freezing temperature of the freezable medium is approximately thirty-two degrees Fahrenheit at sea level and below thirty-five degrees Fahrenheit; however, the exact material and its freezing point may vary depending on the environment and the material chosen. The material may vary depending on costs, intended use, and the needs of the end user.

In some embodiments, the medium may comprise water, and in others, the freezable medium may comprise a freezable gel material, such as a combination of water, propylene glycol, and sodium carboxymethyl cellulose. Yet other embodiments contemplate only consumption-safe materials, in the event of leakage. The insert 80 is removed from the bowl and placed within a freezer or refrigerator environment to chill the insert. When in the freezer, the freezable medium freezes, thereby chilling any food placed within the interior 85 of the liner. To prolong the cool environment provided by the frozen liner 80, the bowl is preferably comprised of a thermally insulating structure. Similar to the liner, the bowl may comprise a heterogeneous structure with a hollow space within at least one of the sidewalls or the base. The hollow space is filled with a thermally insulating material (e.g., insulation material, a vacuum, etc.). Alternatively, the bowl may be comprise of a homogenous or solid material that has thermally insulating properties (i.e. a high thermal resistance).

Overall, the present invention provides a food bowl assembly with freezable insert, an insulating bowl surrounding the insert, and an upstanding post in the insert that supports a temperature indicator. The lid secures over the assembly to maintain freshness of the food and the chilled environment, and further to lock in odors from the food. The lid is preferably water tight and snaps into place onto one of the insert upper edge or the bowl upper edge.

It is submitted, therefore, that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A food bowl assembly, comprising:
an outer bowl having upstanding sidewalls, a base, an upper edge, an open upper, and an interior volume;
a removable insert having a base, upstanding sidewalls, an upper edge, an open upper, and an interior volume;
the outer bowl interior volume and open upper being sized to receive the removable insert therein such that the upper edge of the removable insert is below or substantially in plane with the upper edge of the outer bowl when disposed therein;
an upstanding post member extending from the base of the removable insert and within the interior volume thereof;
the upstanding post member having a height and an upper surface, whereby the height of the upstanding post is less than or substantially in plane with the upper edge of the removable insert;
the upper surface of the upstanding post member having a temperature indicator thereon;
the removable insert comprising a hollow space within at least one of the sidewalls or the base;
whereby the hollow space is filled with a freezable medium that freezes when placed within a residential kitchen freezer.

2) The food bowl assembly of claim 1, further comprising a lid that is removably affixable to the upper edge of the outer bowl.

3) The food bowl assembly of claim 1, wherein the outer bowl further comprises a thermally insulating structure.

4) The food bowl assembly of claim 1, wherein:
the outer bowl further comprises a hollow space within at least one of the sidewalls or the base;
the hollow space of the outer bowl being filled with a thermally insulating material.

5) The food bowl assembly of claim 1, wherein the freezable medium is water.

6) The food bowl assembly of claim 1, wherein the freezable medium is a combination of water, propylene glycol, and sodium carboxymethyl cellulose.

7) The food bowl assembly of claim 1, wherein the freezable medium has a freezing point below thirty-five degrees Fahrenheit.

8) The food bowl assembly of claim 1, wherein the removable insert further comprising a filler hole for filling the hollow space with the freezable medium.

9) A food bowl assembly, comprising:
an outer bowl having upstanding sidewalls, a base, an upper edge, an open upper, and an interior volume;
a removable insert having a base, upstanding sidewalls, an upper edge, an open upper, and an interior volume;
the interior volume and open upper of the outer bowl being sized to receive the removable insert therein such that the upper edge of the removable insert is below or substantially in plane with the upper edge of the outer bowl when disposed therein;
an upstanding post member extending from the base of the removable insert and within the interior volume thereof;
the upstanding post member having a height and an upper surface, whereby the height of the upstanding post is less than or substantially in plane with the upper edge of the removable insert;
the upper surface of the upstanding post member having a temperature indicator thereon;
the removable insert comprising a hollow space within at least one of the sidewalls, the upstanding poste member, or the base;
whereby the hollow space is adapted to be filled with a freezable medium that freezes when placed within a residential kitchen freezer;
the removable liner further comprising a filler hole for filling the hollow space with the freezable medium.

10) The food bowl assembly of claim 9, further comprising a lid that is removably affixable to the upper edge of the outer bowl.

11) The food bowl assembly of claim 9, wherein the outer bowl further comprises a thermally insulating structure.

12) The food bowl assembly of claim 9, wherein:
the outer bowl further comprises a hollow space within at least one of the sidewalls or the base;
the hollow space of the outer bowl being filled with a thermally insulating material.

13) The food bowl assembly of claim 9, wherein the freezable medium is water.

14) The food bowl assembly of claim 9, wherein the freezable medium is a combination of water, propylene glycol, and sodium carboxymethyl cellulose.

15) The food bowl assembly of claim 9, wherein the freezable medium has a freezing point below thirty-five degrees Fahrenheit.
